(19) United States
(12) Patent Application Publication
(10) Pub. No.: US 2008/0298801 A1
(43) Pub. Date: Dec. 4, 2008

(54) ELECTRONIC DISPERSION COMPENSATION SYSTEMS AND METHODS

(75) Inventors: Jonathan Paul King, San Francisco, CA (US); James D. McVey, Palo Alto, CA (US)

Correspondence Address: WORKMAN NYDEGGER, 60 EAST SOUTH TEMPLE, 1000 EAGLE GATE TOWER, SALT LAKE CITY, UT, 84111, US

(73) Assignee: FINISAR CORPORATION, Sunnyvale, CA (US)

(21) Appl. No.: 11/756,580

(22) Filed: May 31, 2007

(51) Int. Cl. H04B 10/08

(52) U.S. Cl. 398/26

(57) ABSTRACT

A test has been developed that is known as the transmitter waveform dispersion penalty (TWDP) test. The TWDP test has been used to test and certify various optical data transmission devices. Similar tests are being developed to test optical receivers such as a difference waveform distortion penalty (dWDP). A test pattern used to generate the transmitted sequence by the device under test is a PRBS9. The PRBS9 test pattern begins with a run of nine ones and has a length of 511 bits. According to the teachings herein, a test pattern of less than 511 bits is generated to perform the TWDP and dWDP tests. The test pattern may include a sequence of bits specifically designed to provide reliable test penalty calculation without the costly and time consuming aspects of the conventional TWDP and dWDP tests using the PRBS9 pattern.

### CROSS-REFERENCE TO RELATED APPLICATIONS

Not applicable.

### BACKGROUND

A test has been developed that is known as the transmitter waveform dispersion penalty (TWDP) test. The TWDP test has been used to test and certify various optical data transmission devices, such as optoelectronic transceivers and calibrated stressed eye generators, for example. In fact, the TWDP test has been used as an industry standard requirement, such as in IEEE 802.3, for certifying certain products.

The TWDP penalty is defined as the difference (in dB) between a reference signal to noise ratio (SNR) and the equivalent SNR at the slicer input of a reference decision feedback equalizer (DFE) receiver for the measured waveform after propagation through a simulated fiber channel. The reference SNR is the SNR of an ideal channel with a matched filter receiver. For the ideal channel, rectangular on-off keyed pulses are transmitted, and the transmitter and fiber are assumed perfect. The received pulse is a rectangular pulse with an amplitude measured in Optical Modulation Amplitude (OMA). The output of the matched filter is sampled once per binary digit (bit) unit interval (without timing error) and presented to the decision element (binary slicer).

The TWDP test involves the use of a computer model having an input as the captured optical transmit waveform. The model for TWDP calculation is illustrated in FIG. 1. The TWDP test and model for TWDP calculation are described in “Explanation of IEEE 802.3, Clause 68 TWDP”, 5 Jan. 2006, by Swenson et al. available on the IEEE website at http://ieee802.org/3/aq/public/tools/TWDP.pdf, the contents of which are hereby incorporated by reference herein. The Swenson paper describes the TWDP test methodology used by the TWDP test procedure and TWDP test algorithm specified in IEEE 802.3-2005 Clause 68 for determining compliance with a 10GBASE-LRM specification, the contents of this standard and the test algorithm disclosed therein are hereby incorporated by reference. For example, the TWDP test algorithm is generally performed for a sampled waveform by execution of the following MATLAB® script used to compute a TWDP:

%%%%%%% MATLAB (R) script to compute TWDP
%%%%%%%%%%%%%%%%%%%%%%
%% TP2 test inputs
%% The values given below for TxDataFile and MeasuredWaveformFile
are examples and should be
%% replaced by actual path\filenames for each waveform tested.
%% Transmit data file: The transmit data sequence is one of the TWDP
test patterns defined in
%% Table 68-6. The file format is ASCII with a single column of
chronological ones and zeros
%% with no headers or footers.
TxDataFile = ‘prbs9_950.txt’;
%% Measured waveform: The waveform consists of exactly N samples
per unit interval T, where N is the
%% oversampling rate. The waveform must be circularly shifted to align
with the data sequence. The file
%% format for the measured waveform is ASCII with a single column of
chronological numerical samples,
%% in optical power, with no headers or footers.
MeasuredWaveformFile = ‘preproc-1207-01.txt’;
OverSampleRate = 16; % Oversampling rate, must be even
%% Simulated fiber responses, modeled as a set of ideal delta functions
with specified amplitudes in optical
%% power and delays in nanoseconds, in rows. The three cases specified
in Table 68-5 for the comprehen-
%% sive stressed receiver tests are used. The vector ‘PCoefs’ contains the
amplitudes, and the vector
%% ‘Delays’ contains the delays.
FiberResp = [...
0.000000 0.072727 0.145455 0.218182
0.158 0.176 0.499 0.167
0.000 0.513 0.000 0.487
0.254 0.453 0.155 0.138];
Delays = FiberResp(1,:)’;
%% Program constants %%
SymbolPeriod = 1/10.3125; % Symbol period (ns)
EqNf = 14; EqNb = 5; % 14 T/2-spaced feedforward equalizer taps; 5 T-
spaced feedback equalizer taps
%% Set search range for equalizer delay, specified in symbol periods.
Lower end of range is minimum
%% channel delay. Upper end of range is the sum of the lengths of the
FFE and channel. Round up and add
%% 5 to account for the antialiasing filter.
EqDelMin = floor(min(Delays)/SymbolPeriod);
EqDelMax = ceil(EqNf/2 + max(Delays)/SymbolPeriod)+5;
EqDelVec = [EqDelMin:EqDelMax];
PAlloc = 6.5; % Total allocated dispersion penalty (dBo)
Q0 = 7.03; % BER = 10\hat{ }(−12)
N0 = SymbolPeriod/2 / (Q0 * 10\hat{ }(PAlloc/10))\hat{ }2;
%% Load input waveform and data sequence, generate filter and other
matrices
yout0 = load(MeasuredWaveformFile);
XmitData = load(TxDataFile);
PtrnLength = length(XmitData);
TotLen = PtrnLength*OverSampleRate;
Fgrid = [−TotLen/2:TotLen/2−1].‘/(PtrnLength*SymbolPeriod);
%% Compute frequency response of 7.5 GHz 4th order Butterworth
antialiasing filter
a = [1 123.1407 7581.811 273453.7 4931335]; % Denominator
polynomial for frequency response
b = 4931335; % Numerator for frequency response
ExpArg = −j*2*pi*Fgrid;
H_r = b./polyval(a,−ExpArg); % Frequency response of Butterworth
antialiasing filter
ONE=ones(PtrnLength,1);
%% Normalize the received OMA to 1. Estimate the OMA of the captured
waveform by using a linear fit to
%% estimate a pulse response, synthesize a square wave, and calculate the
OMA of the sytnhesized square
%% wave per Clause 52.9.5
ant=4; mem=40; % Anticipation and memory parameters for linear fit
X=zeros(ant+mem+1,PtrnLength); % Size data matrix for linear fit
Y=zeros(OverSampleRate,PtrnLength); % Size observation matrix for
linear fit
for ind=1:ant+mem+1
X(ind,:)=circshift(XmitData,ind-ant−1)'; % Wrap appropriately for lin fit
end
Hsys = exp(ExpArg * Delays') * PCoefs; Hx =
fftshift(Hsys/sum(PCoefs));
yout = real(ifft(fft(yout0).*Hx));
%% Process signal through front-end antialiasing filter
%%%%%%%%%%%%%%%%%%
yout = real(ifft(fft(yout) .* fftshift(H_r)));
%% Compute MMSE-DFE
%%%%%%%%%%%%%%%%%%%%%%%%%%%%%%%%
%% The MMSE-DFE filter coefficients computed below minimize mean-
squared error at the slicer input.
%% The derivation follows from the fact that the slicer input over the
period of the data sequence can be
%% expressed as Z = (R+N)*W − X*[0 B]’, where R and N are Toeplitz
matrices constructed from the
%% signal and noise components, respectively, at the sampled output of
the antialiasing filter, W is the
%% feedforward filter, X is a Toeplitz matrix constructed from the input
data sequence, and B is the
%% feedback filter. The computed W and B minimize the mean square
error between the input to the
%% slicer and the transmitted sequence due to residual ISI and Gaussian
noise. Minimize MSE over 2/T
%% sampling phase and FFE delay and determine BER
MseOpt = Inf,
for jj= [0:OverSampleRate−1]-OverSampleRate/2 % sampling phase
%% Sample at rate 2/T with new phase (wrap around as required)
yout_2overT = yout(mod([1:OverSampleRate/2:TotLen]+jj−1,
TotLen)+1); Rout = toeplitz(yout_2overT, [yout_2overT(1);
yout_2overT(end:−1:end−EqNf+2 )]);
R = Rout(1:2:end, :);
RINV = inv([R‘*R+PtrnLength*C R’*ONE;ONE’*R PtrnLength]);
R=[R ONE]; % Add all-ones column to compute optimal offset
Rxr = X‘*R Px_r = Rxx − Rxr*RINV*Rxr’;
%% Minimize MSE over equalizer delay
for kk = 1:length(EqDelVec)
EqDel = EqDelVec(kk);
SubRange = [EqDel+1:EqDel+EqNb+1];
SubRange = mod(SubRange−1,PtrnLength)+1;
P = Px_r(SubRange,SubRange);
P00 = P(1,1); P01 = P(1,2:end); P11 = P(2:end,2:end);
Mse = P00 − P01*inv(P11)*P01';
if (Mse<MseOpt)
MseOpt = Mse;
B = −inv(P11)*P01'; % Feedback filter
XSel = X(:,SubRange);
W = RINV*R'*XSel*[1;B]; % Feedforward filter
Z = R*W − XSel*[0;B]; % Input to slicer
%% STEP 6 − Compute BER using semi-analytic method
%%%%%%%%%%%%%%%%%%
MseGaussian = W(1:end−1)′*C*W(1:end−1);
Ber = mean(0.5*erfc((abs(Z−0.5)/sqrt(MseGaussian))/sqrt(2)));
end
end
end
%% Compute equivalent SNR
%%%%%%%%%%%%%%%%%%%%%%%%%%%%%%%
%% This function computes the inverse of the Gaussian error probability
function. The
%% built-in function erfcinv( ) is not sensitive enough for low probability
of error cases.
if Ber>10\hat{ }(−12) Q = sqrt(2)*erfinv(1–2*Ber);
elseif Ber>10\hat{ }(−323) Q = 2.1143*(−1.0658−log10(Ber)).\hat{ }0.5024;
else Q = inf;
end
%% Compute penalty
%%%%%%%%%%%%%%%%%%%%%%%%%%%%%%%%%%%
RefSNR = 10 * log10(Q0) + PAlloc;
TrialTWDP(ii) = RefSNR−10*log10(Q);
end
%% Pick highest value due to the multiple fiber responses from
TrialTWDP.
TWDP = max(TrialTWDP)
%% End of program

Measuring the TWDP involves capturing a transmitter waveform and processing it using software, including the TWDP algorithm, to calculate the penalty of that waveform on a reference equalizer. The model uses one or more fiber models, assumptions about the receiver noise, and a model of a decision feedback equalizer with a large number of taps (to approximate an ideal infinite equalizer) to calculate the excess power needed to achieve the same BER as the BER of a link with an ideal transmitter signal and perfect fiber response. This calculated penalty should, in turn, correspond to the penalty of an ideal decision feedback equalizer (PIE-D) of the resulting received signal through the actual link.

The test pattern used to generate the transmitted sequence by the device under test is a pseudo-random binary sequence (PRBS) data pattern generated via a maximal length 9^{th} order binary polynomial (PRBS9). The PRBS9 test pattern begins with a run of nine ones and has a length of 511 bits as the last 0 bit of the pattern is appended. This PRBS9 test pattern is generated by a device called a pattern generator which can be quite expensive. For example, a compliant pattern generator, such as the Advantest Pulse Pattern Generator Model D3186, can cost as much as $95,000 U.S. dollars or more. Thus, frequent use of a pattern generator may be cost prohibitive in some instances.

The transmitted sequence must be sampled several times per bit period to capture an accurate waveform. Moreover, the waveform is typically repetitively captured using averaging to avoid a pessimistic estimate of the TWDP. For example, an effective sample rate of at least 7 samples per bit period is typically required. However, interpolation is typically necessary for a waveform not captured with at least 16 samples per bit period. As a result, a high sample rate and/or additional post processing are also required. This post processing may also be cumbersome at least due in part to the length of the PRBS9 test pattern.

The PRBS9 test pattern used to generate the transmitted reference sequence must also be aligned with the captured waveform. For example, although the bit period of the captured waveform is highly accurate, compensation for mismatch on the order of a small fraction of a percent between the transmitted sequence and the captured waveform must be performed. This calibration of the transmitted reference sequence and the captured waveform can be quite time consuming at least due in part to the length of the PRBS9 test pattern sequence and the required number of samples per bit period. For example, in one trial an error in timing calibration of 0.024% was determined to be unsatisfactory.

Similar tests are being developed to test optical receivers. For example, a difference waveform distortion penalty (dWDP) has been proposed for testing SFP type transceivers. dWDP uses the same procedure and code as defined by TWDP in clause IEEE 802.3 clause 68.6.6 with consideration of a few comments. For example, dWDP does not use the three emulated reference multi-mode fibers in the TWDP MATLAB code. The three emulated fibers (the last three rows in FiberResp) are replaced with a single identity channel [0 1 0 0], and therefore, only one penalty value is calculated for each measurement (only one pass of the ii loop). Additional distinctions and explanation of the dWDP test is explained in “SFF-8431 Specifications for Enhanced 8.5 and 10 Gigabit Small Form Factor Pluggable Module ‘SFP+’”, Revision 2.0 (26 Apr. 2007), available at ftp://ftp.seagate.com/sff/SFF-8431.PDF, the contents of which are hereby incorporated by reference.

### BRIEF SUMMARY OF SEVERAL EXAMPLE EMBODIMENTS

A method of testing an optoelectronic device is disclosed. The method includes receiving an electrical test pattern of between about 8 and about 254 bits. The method further includes converting the electrical test pattern to an optical waveform and sampling the optical waveform. The method further includes calculating a penalty. The penalty calculation is associated with a difference in decibels between a reference SNR and an equivalent SNR for the sampled waveform after propagation through a simulated fiber channel.

A system is disclosed that includes a pattern generator configured to generate an electrical test pattern. The system further includes an optical transmitter within the optoelectronic device. The optical transmitter is configured receive an electrical test pattern and convert the electrical test pattern to an optical waveform. The system further includes a sampling device configured to sample the optical waveform and a data processing device configured to calculate a penalty. The penalty calculation is associated with a difference in decibels between a reference SNR and an equivalent SNR for the sampled waveform after propagation through a simulated fiber channel.

An optoelectronic device is also disclosed. The optoelectronic device includes an optical transmitter, a pattern generator coupled to the optical transmitter, and a housing containing at least the optical transmitter and the pattern generator. The pattern generator is configured to generate a test pattern of between about 8 and 254 binary digits (bits) and transmit the test pattern to the optical transmitter.

These and other aspects of the present invention will become more fully apparent from the following description and appended claims.

### BRIEF DESCRIPTION OF THE DRAWINGS

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates the model for TWDP calculation.

FIG. 2 discloses a system for testing an optoelectronic device.

FIG. 3 discloses a system for testing a fiber optic transceiver.

FIG. 4 discloses a system for testing an optoelectronic device.

FIG. 5 discloses a system for testing a fiber optic transceiver.

FIG. 6 discloses an example of a 32 bit test pattern.

FIG. 7 is a plot of the digital sum variation (DSV) of three test patterns.

FIG. 8 discloses a method of testing an optoelectronic device.

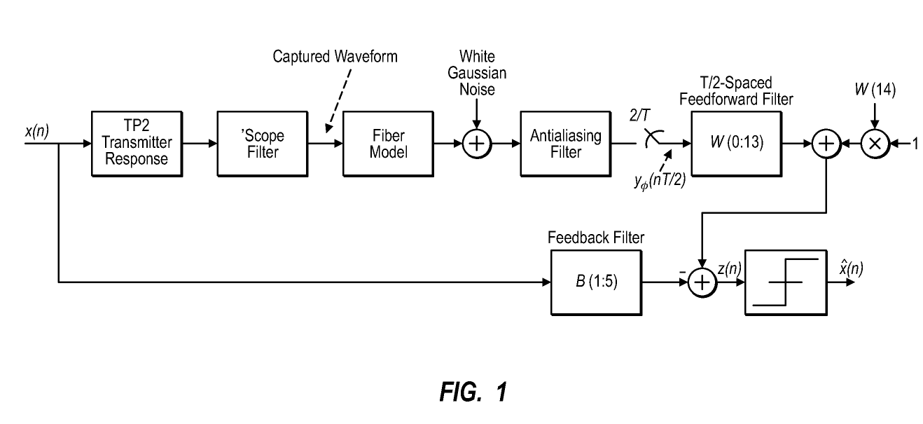

### DETAILED DESCRIPTION OF SEVERAL EMBODIMENTS

As described above, a TP-2 test methodology has been developed for determining compliance with 10GBASE-LRM specifications. In this conventional test, a measured waveform from a device under test (DUT) is captured with a sampling oscilloscope and the data sequence driving the DUT is a PRBS9 or similar test pattern. According to the teachings herein, a test pattern shorter than the PRBS9 test pattern is used to determine whether the DUT is in compliance with a specification.

Using the shortened test pattern for TDWP testing according to the teachings herein may introduce several advantages over the industry standard method. For example, the cost of the pattern generator may be reduced in some instances due to the shorted test pattern. The pattern generator may also be a less complicated device. As such, the pattern generator may be disposed internal to the DUT and included within the final product. As such, a separate external pattern generator would not be required in such embodiments. Moreover, in some embodiments, circuitry already included within a product may be simply reprogrammed so as to generate the test pattern without requiring additional hardware.

In addition, as discussed above, the test pattern used to generate the transmitted sequence must be aligned with the captured waveform. It follows that the alignment of a shorter transmitted sequence with the captured waveform may be accomplished in less time than a longer transmitted sequence. Thus, setup, calibration, and time spent performing post-processing may be drastically reduced, particularly so where the transmitted sequence is a small fraction of the length of the standard PRBS9 sequence.

In some instances, the bit pattern of the shortened test pattern may also be designed as an pre-certification test so as to provide a good indication of whether the DUT would subsequently also satisfy the standard TDWP test using the PRBS9 test pattern. The test pattern may be designed so as to provide a sequence of bits most likely to cause a DUT to fail a TDWP certification test. Thus, the bit pattern can be designed to introduce error in a test pattern including a shorter length of bits. As such, the shortened TDWP test pattern can give a reliable pre-final assembly and test indication of whether the DUT will fail the industry standard test.

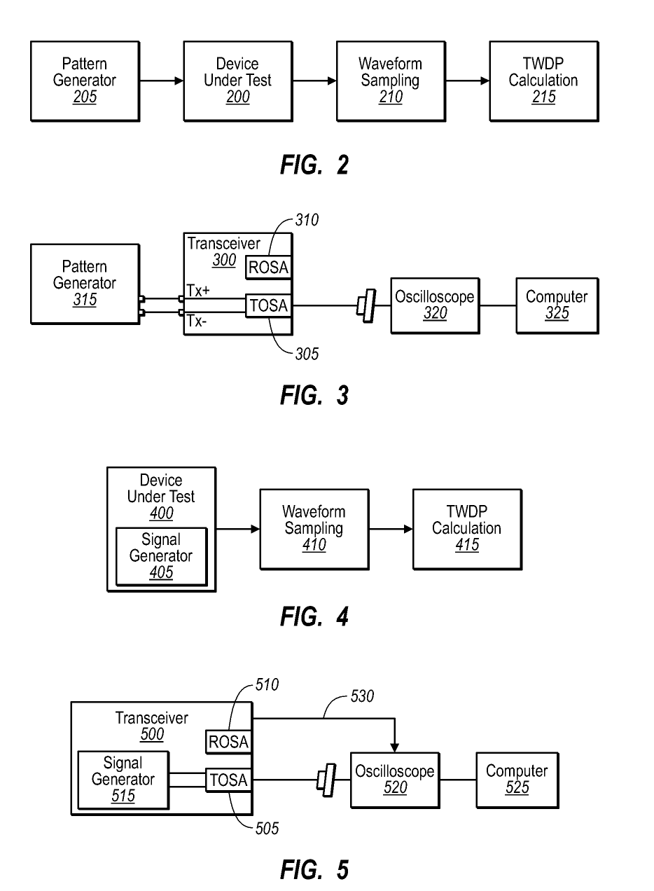

Referring to FIG. 2, a system for testing an optoelectronic device is disclosed. The system includes the optoelectronic device 200 under test, a pattern generator 205, a waveform sampling device 210, and a device for calculating a TWDP 215. The optoelectronic device 200 can be an optoelectronic transceiver or a calibrated stressed eye generator, for example. The waveform sampling device 210 can be an optical oscilloscope, for example.

The TWDP calculation device 215 may include a conventional computer or other data processing device. The TWDP calculation includes processing the waveform generated by the optoelectronic device 200 sampled using software, including the TWDP algorithm, to calculate the penalty of that waveform on a reference equalizer as discussed above. The penalty calculated can characterize an optical transmitter or an optical receiver within the optoelectronic device 200. Three fiber channels can be simulated, each fiber channel corresponding to a defined stressor. A penalty for each of the three simulated fiber channels may be calculated and a maximum penalty of the penalties calculated is identified. The penalty(s) are compared to a penalty threshold to determine whether the optoelectronic device is compliant. The penalty threshold may be determined by an industry standard, such as a 10GBASE-LRM specification.

The pattern generator 205 is configured to generate an electrical test pattern that is less than the 511 bits long. In one embodiment, the test pattern is between about 8 and 254 bits. In another embodiment, the pattern generator is configured to generate an electrical test pattern that is between about 10 and 64 bits. According to another embodiment, the pattern generator is configured to generate an electrical test pattern that is about 32 bits or less. The test pattern maybe transmitted at speeds of between about 8 and about 10 gigabits per second (Gbps), for example. However, the teachings disclosed herein are applicable to testing conducted at speeds higher than 10 Gbps and less than 8 Gbps. Thus, in this embodiment the pattern generator 205 is located external to the optoelectronic device under test 200.

Referring to FIG. 3, a system for testing a fiber optic transceiver 300 is illustrated. The system includes the fiber optic transceiver 300, a pattern generator 315, an oscilloscope 320, and a computer 325. The fiber optic transceiver 300 include one or more optical subassemblies (OSA) such as a transmit optical subassembly (TOSA) 305 for sending optical signals, and a receive optical subassembly (ROSA) 310 for receiving optical signals. More particularly, the TOSA 305 has an optical transmitter that receives an electrical data signal and converts the electrical data signal into an optical data signal. The ROSA 310 has an optical receiver that receives an optical data signal and converts the received optical data signal to an electrical data signal for further use and/or processing. Both the ROSA 310 and the TOSA 305 include specific optical components for performing such functions.

For example, the TOSA 305 can include an optical transmitter in the form of a light emitting diode (LED) or a laser diode located on a header for transmitting an optical signal to an optical fiber. A plastic barrel can be used to align and couple the optical signal transmission from the optical transmitter with the end of a fiber optic cable. Similarly, the ROSA 310 can include an optical receiver in the form of a PIN photodiode or avalanche photodiode (“APD”), located on a header. A plastic barrel can be used to align and couple the end of a fiber optic cable for transmission of the optical signal from a fiber optic cable to the optical receiver. Thus, testing of the optical transmitter and/or the optical receiver of the fiber optic transceiver using the shortened test pattern may, in some embodiments, help to determine whether the transceiver will subsequently satisfy a TWDP or dWDP requirement.

Referring to FIG. 4, a system for testing an optoelectronic device is illustrated. Similar to FIG. 2, the system includes an optoelectronic device under test 400, a waveform sampling device 410, and a TWDP calculation device 415. In this embodiment, however, a signal generator 405 is disposed within the optoelectronic device 400. The signal generator 405 can include circuitry configured to generate the test pattern. The sole purpose of the circuitry can be to generate the test pattern; or the circuitry can have additional utility and function within the optoelectronic device 400. For example, the circuitry can include control functions for controlling a transmit and/or receive function of the optoelectronic device 400.

In another embodiment, the circuitry is configured to provide additional testing functionality for the optoelectronic device 400. For example, the circuitry may have the dual function of generating the test pattern for TWDP or dWDP testing along with the function of generating a different test pattern for another industry standard test, such as any of the tests requiring test patterns disclosed in IEEE 802.3 or other industry standard.

Referring to FIG. 5, a system for testing a fiber optic transceiver 500 is illustrated. The system disclosed in FIG. 5 is similar to the system disclosed in FIG. 3 in that the system includes the fiber optic transceiver 500, an oscilloscope 520 for sampling a waveform generated by the fiber optic transceiver 500, and a computer 525 for calculating the TWDP penalty(s). However, in this embodiment, the transceiver 500 includes a signal generator 515 in addition to a TOSA 505 and ROSA 510 and a trigger connection 530 for providing a transmit clock output to trigger the oscilloscope 520. The signal generator is electrically coupled to the TOSA 505 and provides the electrical test pattern to the TOSA 505. In one embodiment a XAUI source within the fiber optic transceiver 500 provides the test pattern. In another embodiment, a single controller integrated circuit controls other aspects of the transceiver function as well as generating the test pattern. For example, see United States Patent Application Publication No. 20050078916, the contents of which are hereby incorporated by reference herein.

The fiber optic transceiver 500 can be any type of fiber optic transceiver. For example, the fiber optic transceiver 500 can be a small form-factor pluggable (SFP), SFP+, a small form-factor (SFF), a 10 gigabit small form factor pluggable (XFP), ZENPAK, XPAK, gigabit Ethernet, GBIC, or other type of fiber optic transceiver.

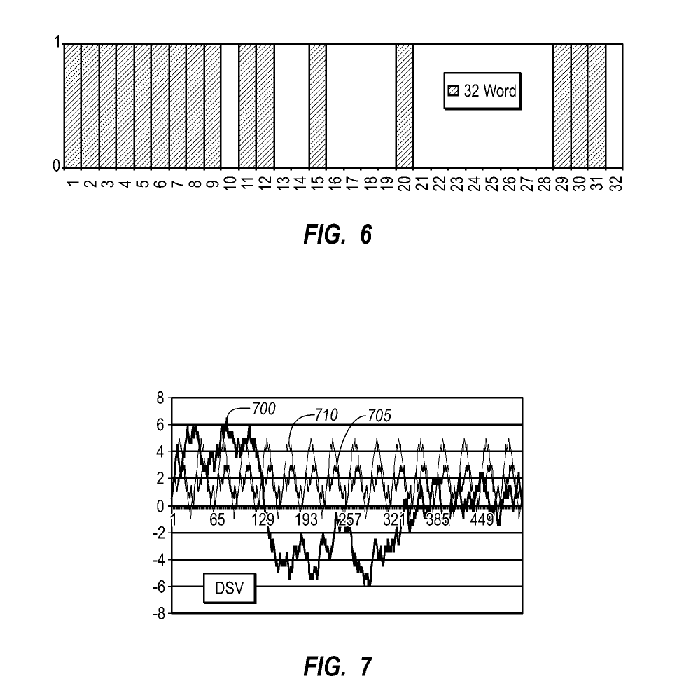

Referring to FIG. 6, an example of a 32 bit test pattern is illustrated. The test pattern shown in FIG. 6 illustrates the manner in which a test pattern can be designed to introduce error in a relatively short test pattern. For example, testing has revealed that long runs of consecutive bits tend to cause error and identify non-compliant optoelectronic devices. Therefore, the test pattern in FIG. 6 has been designed to include nine consecutive 1 bits. In addition, the test pattern also includes nine consecutive 0 bits.

Testing has also revealed that isolated bits adjacent to long runs of the opposite bit value tend to introduce error. Therefore, the test pattern in FIG. 5 as been designed to include an isolated 1 bit followed by nine 0 bits. Similarly, the test pattern further includes an isolated 0 bit preceded by nine 1 bits. Thus, a test pattern of any length may be designed such that the pattern of bits includes long run of bits of the same value, for example as long as five, nine, or more bits of the same value, as well as isolated bits adjacent to, or surrounded by, long runs of bits of the opposite value. As a result, the test pattern may be shortened, but be specifically designed to include a test pattern selected to increase the likelihood of identifying non-compliant optoelectronic components in a TWDP test.

In some instances an optoelectronic device maybe more sensitive to a test pattern associated with a large digital sum variation (DSV). Therefore, one manner in which the design of a test pattern may be evaluated is by comparison of a DSV for different test patterns. For example, referring to FIG. 7 the DSV of three test patterns is shown. The DSV calculation in this example is calculated as the cumulative sum of 1 bits assigned the value +0.5 and 0 bits assigned the value −0.5. First a plot of the PRBS9 DSV 700 is shown. The DSV for the PRBS9 test pattern has a value of 12.5 as the DSV varies from a negative six to a positive 6.5. Next, a plot of a PRBS5 test pattern DSV 700 is shown. The DSV value of PRBS5 is illustrated as the PRBS5 has a similar number of bits to the test pattern shown in FIG. 6. The PRBS5 test pattern has a DSV of 3 as it varies from zero to positive three as shown in FIG. 7. However, the DSV associated with the test pattern of FIG. 6 710 is six as shown in FIG. 7 as it varies from zero to positive six. Thus, as a result of its bit pattern, the DSV associated with the test pattern of FIG. 6 is twice as large as the DSV associated with the PRBS5 test pattern even though both test patterns have a similar number of bits. Therefore, in such instances a bit pattern designed so as to provide an increased DSV may identify errors that would not otherwise be identified or may be shortened and still subject the optoelectronic device to an accurate certification. In one trial, for example, the TWDP calculated using the test pattern of FIG. 6 gave about the same TWDP as calculated using a PRBS9 test pattern. Thus, certification of an optoelectronic device using a 32 bit pattern, such as that shown in FIG. 6, may give a reliable indication of whether the optoelectronic device will also satisfy a TWDP certification using the PRBS9 test pattern.

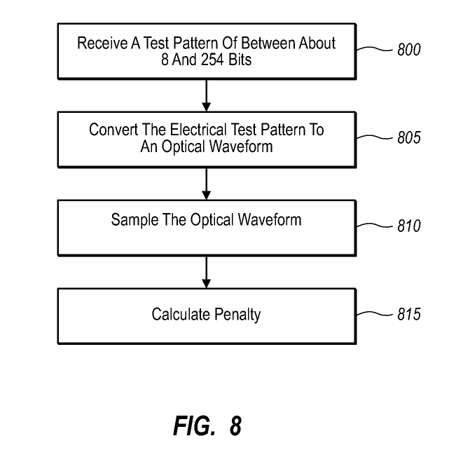

FIG. 8 illustrates a method of testing an optoelectronic device. The method includes receiving an electrical test pattern of between about 8 and about 254 bits (800). In some embodiments the test pattern is between about 10 and about 64 bits, or is about 32, or fewer, bits. In some embodiments, the test pattern is repetitively received until at least 511 bits are received. The test pattern can be designed to include a pattern of bits designed to introduce error as discussed above. For example, the test pattern can include runs of same-value bits and/or isolated bits. The electrical test pattern may be repetitively received. For example, the electrical test pattern may be repetitively received such that a total of 511 bits or more are received.

The method further includes converting the electrical test pattern to an optical waveform (805). The method further includes sampling the optical waveform (810). The method further includes calculating a penalty (815). The penalty calculation is associated with a difference in decibels between a reference SNR and an equivalent SNR for the sampled waveform after propagation through a simulated fiber channel. For example, the penalty calculation can include the TWDP test algorithm specified in IEEE 802.3-2005, Clause 68. The penalty calculation can include simulating three fiber channels, each fiber channel corresponding to a defined stressor, calculating a penalty for each of the three simulated fiber channels, and identifying a maximum penalty of the penalties calculated.

In one embodiment, the method of FIG. 8 is used to test a laser of an optoelectronic device for a TWDP associated with the laser using the TWDP algorithm discussed above. In another embodiment, the method of FIG. 8 is used to test an optical receiver of an optoelectronic device for dWDP associated with the optical receiver in accordance with the SFF-8431 proposed specification.

It should be understood that the drawings are diagrammatic and schematic representations of such example embodiments and, accordingly, are not limiting of the scope of the present invention, nor are the drawings necessarily drawn to scale. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. Detailed descriptions of apparatus and processing techniques known in the field of the invention to one of ordinary skill in the art have been excluded.

We claim:

1. A method of testing an optoelectronic device, comprising the following acts:
receiving an electrical test pattern of between about 8 and about 254 binary digits (bits);
converting the electrical test pattern to an optical waveform;
sampling the optical waveform; and
calculating a penalty, wherein the penalty calculation is associated with a difference in decibels between a reference signal to noise ratio (SNR) and an equivalent SNR for the sampled waveform after propagation through a simulated fiber channel.

2. A method according to claim 1, wherein the penalty is calculated using a TWDP test algorithm.

3. A method according to claim 1, wherein the optoelectronic device includes a laser and the penalty calculated includes a transmitter waveform dispersion penalty (TWDP) associated with the laser.

4. A method according to claim 1, wherein the optoelectronic device includes an optical receiver and the penalty calculated is a difference waveform distortion penalty (dWDP) associated with the optical receiver.

5. A method according to claim 1, wherein the electrical test pattern is between about 10 bits and about 64 bits.

6. A method according to claim 1, wherein the electrical test pattern is about 32 bits or fewer bits.

7. A method according to claim 1, further comprising repetitively receiving the electrical test pattern until at least 511 bits are received, and wherein the penalty calculation includes 511 received bits as an input to determine the equivalent SNR.

8. A method according to claim 1, wherein the electrical test pattern includes at least nine consecutive 1 bits.

9. A method according to claim 1, wherein the electrical test pattern includes at least nine consecutive 0 bits.

10. A method according to claim 1, wherein the electrical test pattern includes an isolated 1 bit adjacent to at least nine 0 bits.

11. A method according to claim 10, wherein the isolated one bit is preceded by at least four 0 bits.

12. A method according to claim 1, wherein the electrical test pattern includes an isolated 0 bit preceded by at least one 1 bit, wherein the isolated 0 bit is followed by at least nine 1 bits.

13. A method according to claim 1, wherein the electrical test pattern is associated with a digital sum variation (DSV) value of greater than three.

14. A method according to claim 1, further comprising:
simulating three fiber channels, each fiber channel corresponding to a defined stressor;
calculating a penalty for each of the three simulated fiber channels; and
identifying a maximum penalty of the penalties calculated.

15. A system configured to perform the method of claim 1, the system comprising:
a pattern generator configured to generate the electrical test pattern;
an optical transmitter within the optoelectronic device and configured receive the electrical test pattern and convert the electrical test pattern to an optical waveform;
a sampling device configured to sample the optical waveform; and
a data processing device configured to calculate the penalty.

16. A system according to claim 15, wherein the sampling device includes an oscilloscope.

17. A system according to claim 15, wherein the optoelectronic device includes a transceiver or a stressed eye generator, wherein the transceiver or stressed eye generator includes a housing containing the pattern generator and the optical transmitter.

18. A system according to claim 15, wherein the optoelectronic device includes a transmit clock output configured to provide a trigger signal for the sampling device.

19. An optoelectronic device comprising:
an optical transmitter;
a pattern generator coupled to the optical transmitter, the pattern generator being configured to generate a test pattern of between about 8 and 254 binary digits (bits) to the optical transmitter; and
a housing containing at least the optical transmitter and the pattern generator.

20. A optoelectronic device according to claim 19, wherein the electrical test pattern is between about 10 bits and about 64 bits.

21. A optoelectronic device according to claim 19, wherein the electrical test pattern is about 32 bits or fewer bits.

22. A optoelectronic device according to claim 19, wherein the electrical test pattern includes an isolated 1 bit preceded by a 0 bit, wherein the isolated 1 bit is followed by nine 0 bits and an isolated 0 bit preceded by a 1 bit, wherein the isolated 0 bit is followed by nine 1 bits.

23. A optoelectronic device according to claim 19, wherein the optoelectronic device includes an optoelectronic transceiver.

24. The optoelectronic device of claim 19, further comprising:
a transmit clock output configured to provide a trigger signal for a sampling device.
